(19) United States
(12) Patent Application Publication
(10) Pub. No.: US 2006/0081241 A1
(43) Pub. Date: Apr. 20, 2006

(54) Small disposable medical device

(76) Inventor: George Edward Quinn, Delaware, OH (US)

Correspondence Address: Patrick P. Phillips;Kremblas, Foster, Phillips & Pollick, 7632 Slate Ridge Blvd., Reynoldsburg, OH, 43147, US

(21) Appl. No.: 10/941,362

(22) Filed: Sep. 15, 2004

(51) Int. Cl. A62B 7/00

(52) U.S. Cl. 128/200.24

(57) ABSTRACT

A small, disposable, medical device is provided having a central housing, a proximal end portion, and a distal end portion, with the central housing having the proximal end portion at one end of the central housing, and the distal end portion at the other end. The proximal end portion and the distal end portion each have an aperture formed therein, with a channel extending the length of the device from one aperture to the other. The device's central housing tapers in width between the proximal end portion and the distal end portion, with the width at the distal end portion being less than the width at the proximal end portion. The proximal end portion preferably has a width that is greater than its height. Further, the aperture at the proximal end has an area that is greater than the aperture at the distal end. Additionally, the central housing includes a sloping upper surface and a sloping lower surface, with the sloping upper surface terminating at the top surface tip, and with the sloping lower surface terminating at the bottom surface tip.

### BACKGROUND OF THE INVENTION

1. Field of the Invention

This invention relates generally to medical devices that can assist a person's breathing, and more particularly, to such devices that improve the oxygen level in the bloodstream, and more particularly to such devices that are small, portable and disposable.

2. Description of the Related Art

This invention is directed to the providing of a small, portable medical device that can assist a person's breathing, with the device also preferably being disposable. Millions of people are afflicted with diseases targeting the lungs. Some of these diseases include emphysema and pulmonary fibrosis.

Over 3 million Americans have been diagnosed with emphysema. Emphysema begins with the destruction of the alveoli, which eventually results in less oxygen being transferred from the lungs to the bloodstream, ultimately causing difficulty in breathing and shortness of breath.

Over 200,000 Americans have been diagnosed with pulmonary fibrosis, with over 5 million people worldwide being affected by this disease. Over 40,000 people die annually from this disease, approximately the same number as those who die annually from breast cancer. Pulmonary fibrosis results in the scarring of the lung tissue, consequently resulting in the loss of the lungs' ability to transport oxygen. The oxygen level in the bloodstream is lowered, once again ultimately causing difficulty in breathing and shortness of breath.

Unfortunately, no cure exists for either disease. While a variety of treatment options exist, pulmonary hypertension and respiratory failure usually precede a premature death. Treatment options include lung transplantation and pharmaceutical therapy, however in the case of pulmonary fibrosis the therapeutic approach has remained basically unchanged for the last 30 years, not because it is efficacious, but because nothing better has come along. Providing supplemental oxygen often is necessary to maintain a satisfactory level of quality of life, but typically creates lifestyle limitations. According to reports, millions of individuals use supplemental oxygen. These treatment options, in addition to being costly, also often offer little in the way of long term relief.

It is thus apparent that the need exists for a more efficacious treatment option for use by individuals who suffer with emphysema or pulmonary fibrosis. An important aspect of such a treatment option would be to provide an option that does not cause significant, adverse impact on the user financially. Furthermore, it would be desirable for such an option to be readily available to users, thus not limiting mobility.

### SUMMARY OF THE INVENTION

In accordance with the present invention, there is disclosed a small, disposable, medical device having a central housing, a proximal end portion, and a distal end portion, with the central housing having the proximal end portion at one end of the central housing, and with the central housing having the distal end portion at the other end of the central housing. The proximal end portion has an aperture formed therein and the distal end has an aperture formed therein, with a channel extending the length of the device from the aperture at the proximal end to the aperture at the distal end.

The device's central housing tapers in width between the proximal end portion and the distal end portion, with the width at the distal end portion being less than the width at the proximal end portion. The proximal end portion preferably has a width that is greater than its height. Further, the aperture at the proximal end has an area that is greater than the aperture at the distal end.

Also, the aperture at the distal end has a top surface tip and a bottom surface tip, with a tip exterior surface extending from the top surface tip to the bottom surface tip. Additionally, the central housing includes a sloping upper surface and a sloping lower surface, with the sloping upper surface terminating at the top surface tip, and with the sloping lower surface terminating at the bottom surface tip. The device is of a length between 1.25″ to 8″. More preferably, the device is of a length between 1.5″ and 3″.

There is also disclosed a small, disposable medical device having a longitudinal member, a mouthpiece, and an outflow portion, with the longitudinal member having the mouthpiece at one end of the longitudinal member, and with the longitudinal member having the outflow portion at the other end of the longitudinal member. The mouthpiece has an aperture formed therein and the outflow portion has an aperture formed therein, with a channel extending the length of the device from the aperture at the mouthpiece to the aperture at the outflow end.

The longitudinal member tapers in width between the mouthpiece and the outflow portion, with the width at the outflow portion being less than the width at the mouthpiece. Preferably, the mouthpiece has a width that is greater than its height. The aperture at the mouthpiece has an area that is greater than the aperture at the outflow portion.

The aperture at the outflow portion has a top surface tip and a bottom surface tip, with a tip exterior surface extending from the top surface tip to the bottom surface tip. The longitudinal member preferably has a sloping upper surface and a sloping lower surface, with the sloping upper surface terminating at the top surface tip, and with the sloping lower surface terminating at the bottom surface tip. The device is of a length between 1.25″ to 8″. More preferably, the device is of a length between 1.5″ and 3″.

The primary objective of this invention is to provide an efficacious treatment option for use by individuals who suffer with emphysema or pulmonary fibrosis.

Another objective of this invention is to provide such a treatment option that does not cause significant, adverse impact on the user financially.

Still another objective of this invention is to provide such an option that could be readily available to its users, thus not limiting their mobility.

Yet another objective of this invention is to provide a device that is relatively economical to make, so that it can be disposed of and readily replaced.

Other objects and advantages of the invention will be apparent from the following description, the accompanying drawings and the appended claims.

### BRIEF DESCRIPTION OF THE DRAWINGS

FIG. 1 is a perspective view of a small, disposable, medical device made in accordance with the present invention.

FIG. 2 is a side elevational view taken from the right side of FIG. 1.

FIG. 3 is a top plan view of the invention.

FIG. 4 is a bottom plan view of the invention.

FIG. 5 is a vertical sectional view of the invention taken along line 5-5 of FIG. 3.

FIG. 6 is a horizontal sectional view of the invention taken along line 6-6 of FIG. 5.

FIG. 7 is a front elevational view of the invention.

FIG. 8 is a rear elevational view of the invention.

FIG. 9 is a perspective view of a modified embodiment of the small, disposable, medical device made in accordance with the present invention.

FIG. 10 is a side elevational view taken from the right side of FIG. 9.

FIG. 11 is a top plan view of the embodiment of the invention shown in FIG. 9.

FIG. 12 is a bottom plan view of the embodiment of the invention shown in FIG. 9.

FIG. 13 is a vertical sectional view of the embodiment of the invention shown in FIG. 9 taken along line 13-13 of FIG. 11.

FIG. 14 is a horizontal sectional view of the embodiment of the invention shown in FIG. 9 taken along line 14-14 of FIG. 13.

FIG. 15 is a front elevational view of the modified embodiment of the invention shown in FIG. 9.

FIG. 16 is a rear elevational view of the invention shown in FIG. 9.

In describing the preferred and modified embodiments of the invention which are illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

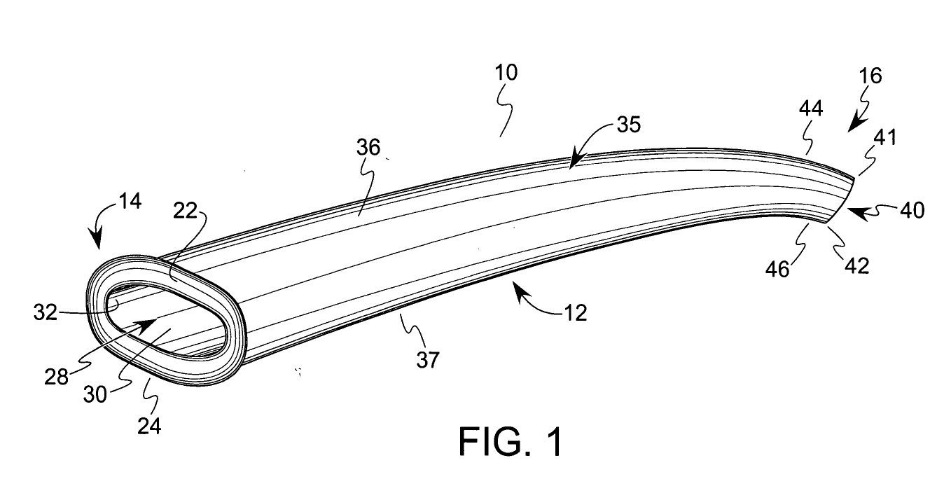

Having reference to the drawings, attention is directed first to FIG. 1, which discloses a small, disposable, medical device made in accordance with the invention designated generally by the numeral 10. The device can be fabricated from a variety of materials known in the manufacture of medical devices, although plastic or substances similar thereto are preferred.

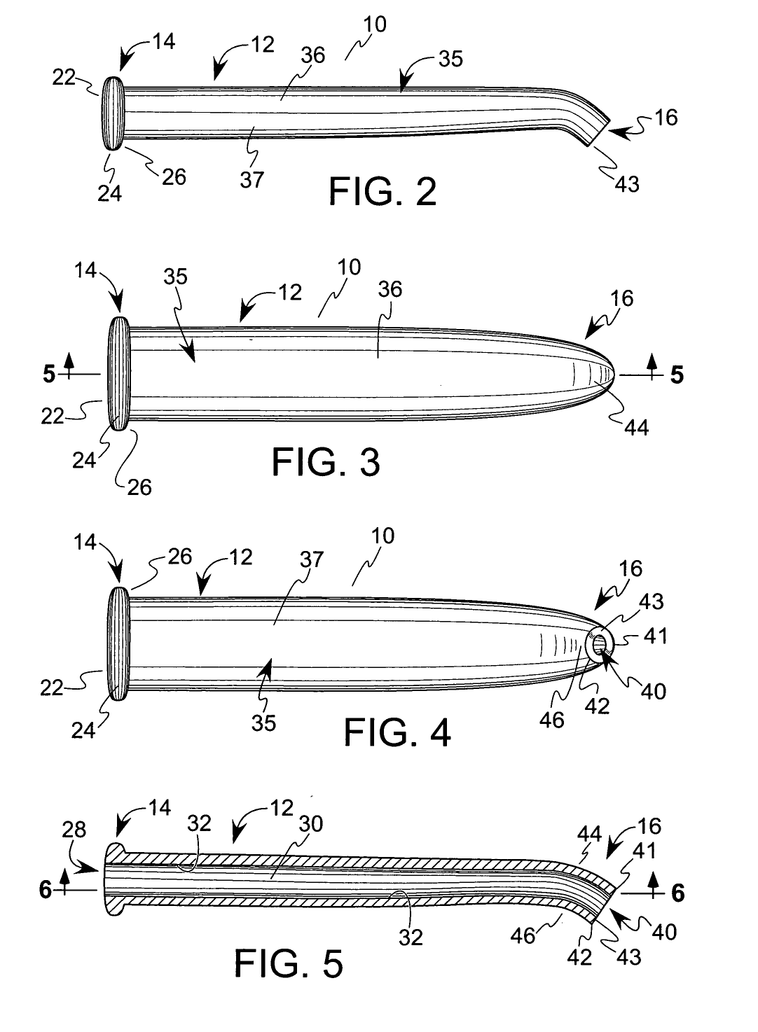

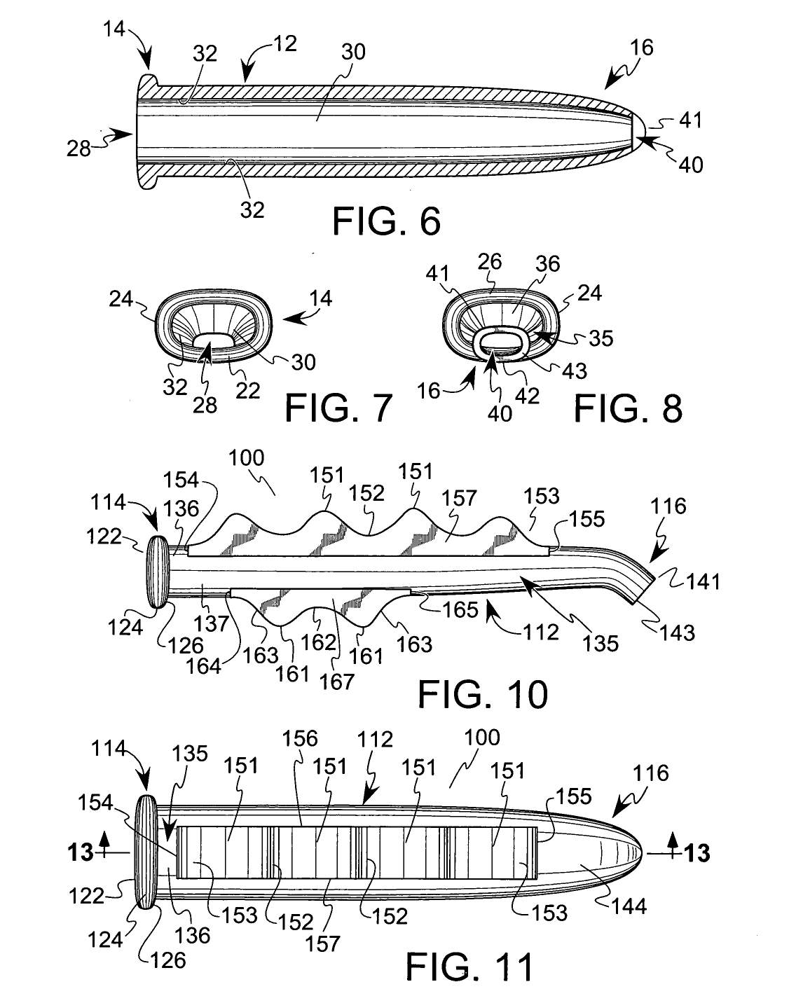

Each device 10 includes a central housing portion 12, a proximal end portion 14, and a distal end portion 16. As can be appreciated from a comparison of FIGS. 1-6, the central housing 12 can be appreciated as forming a longitudinal member with a mouthpiece 14 and an outflow portion 16 at its opposite ends. The central housing in one specific embodiment of the invention extends a distance greater than 2″.

From a comparison of FIGS. 1 and 7, the mouthpiece 14 is preferably formed having a width dimension that is greater than its height. Thus it is shown as being of a generally oval or oblate cross-section, with the width dimension being about twice the height. As can better be appreciated from a comparison of FIGS. 1, 2, and 5, the mouthpiece 14 has a front surface 22, a rear surface 26 directly adjacent the exterior wall 35 of the central housing, and a peripheral surface 24 shown as having a rounded sidewall.

A comparison of FIGS. 1, 5, 6, and 7 discloses that the proximal end portion 14 has a proximal end aperture 28 formed therein which leads to a channel 30 having a channel interior wall 32. The channel 30 extends the length of the device 10. Preferably, the channel interior wall 32 has a curved sidewall as can perhaps best be appreciated from a comparison of FIGS. 5, 6, 7, and 8. In the preferred embodiment, the channel curves downwardly between the proximal and distal ends.

Meanwhile, the central housing 12 also has an exterior wall 35 with a top surface 36 and a bottom surface 37 as can be appreciated from a comparison of FIGS. 1-4. These drawings also disclose that in the embodiment shown, the height of the mouthpiece is greater than the height of the central housing, although this need not be the case. This longitudinal member is of a slightly tapered, generally cylindrical configuration, with the width of the longitudinal member being greater at the proximal end of the device than at the distal end. Additionally, in this particular embodiment of the invention, both the top and bottom surfaces, 36 and 37 respectively, are substantially smooth.

A comparison of FIGS. 4, 5, and 8 discloses that the distal end 16 of the device 10 includes a distal end aperture 40 having a top surface tip 41 and a bottom surface tip 42. The distal end aperture 40 approximates a circle in the embodiment shown, with a diameter of approximately 0.25″. Connecting the top surface time 41 and the bottom surface tip 42 is a tip exterior surface 43, such that the tip exterior surface appears to be beveled in comparison to the longitudinal axis associated with the central housing 12.

The distal end portion 16 also features a sloping upper surface 44 and a sloping lower surface 46, with the length of the upper surface 44 being greater than the distance of the lower surface 46 due to the curvature of the device 10 in that portion of the device. It will also be appreciated that the area of the distal end aperture 40 is less than the area of the proximal end aperture 28.

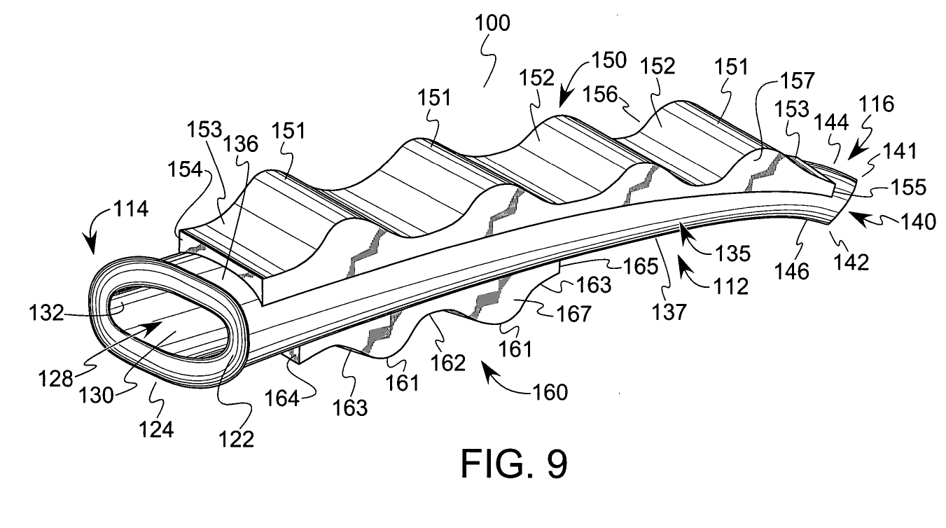

FIG. 9 discloses a modified embodiment of the small, disposable, medical device of this invention designated generally by the numeral 100. Once again, the device can be fabricated from a variety of materials known in the manufacture of medical devices, although plastic or substances similar thereto are preferred.

Each device 100 includes a central housing portion 112, a proximal end portion 114, and a distal end portion 116. As can be appreciated from a comparison of FIGS. 9-14, the central housing 112 can be appreciated as forming a longitudinal member with a mouthpiece 114 and an outflow portion 116 at its opposite ends. The central housing in one specific embodiment of the invention extends a distance greater than 2″.

From a comparison of FIGS. 9 and 15, the mouthpiece 114 is preferably formed having a width dimension that is greater than its height. Thus it is shown as being of a generally oval or oblate cross-section, with the width dimension being about twice the height. As can better be appreciated from a comparison of FIGS. 9, 10, and 13, the mouthpiece 114 has a front surface 122, a rear surface 126 directly adjacent the exterior wall 135 of the central housing, and a peripheral surface 124 shown as having a rounded sidewall.

A comparison of FIGS. 9, 13, 14, and 15 discloses that the proximal end portion 114 has a proximal end aperture 128 formed therein which leads to a channel 130 having a channel interior wall 132. The channel 130 extends the length of the device 100. Preferably, the channel interior wall 132 has a curved sidewall as can perhaps best be appreciated from a comparison of FIGS. 13, 14, 15, and 16.

Meanwhile, the central housing 112 also has an exterior wall 135 with a top surface 136 and a bottom surface 137 as can be appreciated from a comparison of FIGS. 9-12. These drawings also disclose that in the embodiment shown, the height of the mouthpiece is greater than the height of the central housing, although this need not be the case. This longitudinal member is of a slightly tapered, generally cylindrical configuration, with the width of the longitudinal member being greater at the proximal end of the device than at the distal end. Additionally, in this particular embodiment of the invention, both the top and bottom surfaces, 136 and 137 respectively, are substantially smooth, except for gripping portions 150 and 160.

The first digital engaging portion 150 can best be appreciated from a comparison of FIGS. 9, 10, 11, 13, and 15. This raised portion on the top surface 136 of the device includes at least one and in the preferred embodiment of the invention a plurality of crests 151 and troughs 152. Intermediary sloping portions 153 extend between the front wall 154 and the rear wall 155, respectively, of the first digital engaging portion 150 and the crest directly adjacent to each of such walls. Extending along the opposite sides of the first digital engaging means from the front wall 154 to the rear wall 155 are first side wall 156 and second side wall 157.

Meanwhile, the second digital engaging portion 160 can best be appreciated from a comparison of FIGS. 9, 10, 12, 13, and 16. This raised portion on the bottom surface 137 of the device includes at least one and in the preferred embodiment of the invention a plurality of crests 161. Where there are two crests, a trough 162 exists therebetween. Intermediary sloping portions 163 extend between the front wall 164 and the rear wall 165, respectively, of the second digital engaging portion 160 and the crest directly adjacent to each of such walls. Extending along the opposite sides of the second digital engaging means from the front wall 164 to the rear wall 165 are first side wall 166 and second side wall 167.

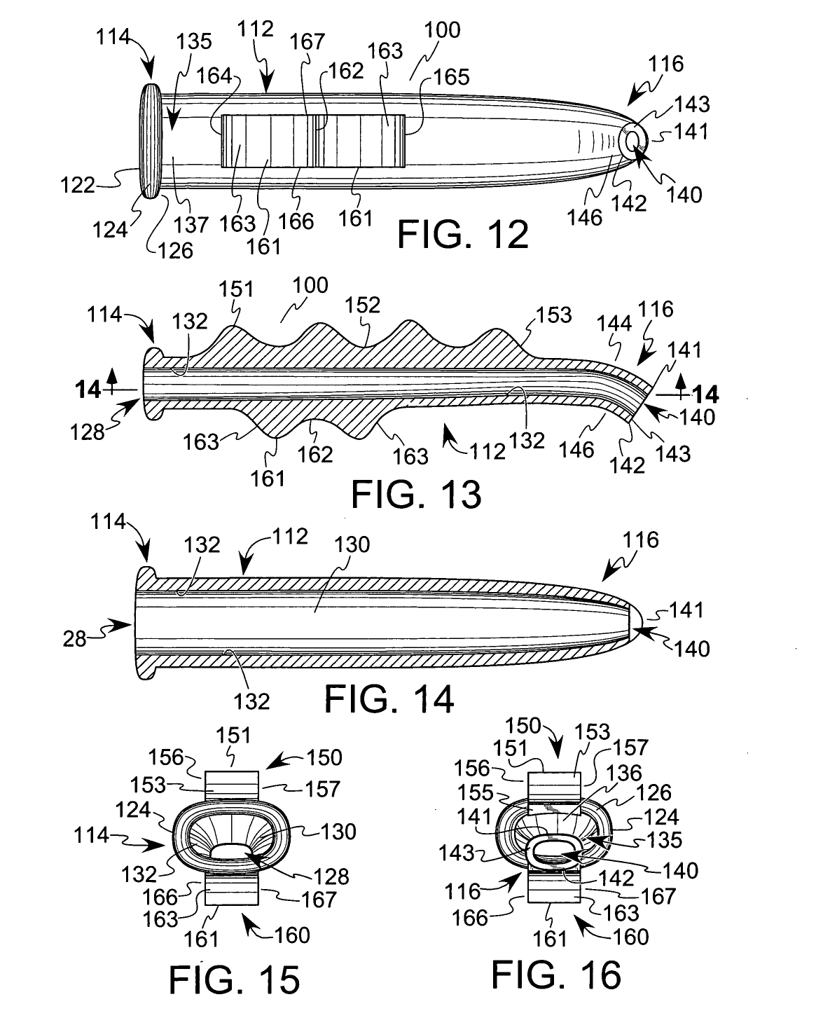

A comparison of FIGS. 12, 13, and 16 discloses that the distal end 116 of the device 100 includes a distal end aperture 140 having a top surface tip 141 and a bottom surface tip 142. The distal end aperture 140 approximates a circle in the embodiment shown, with a diameter of approximately 0.25″. Connecting the top surface time 141 and the bottom surface tip 142 is a tip exterior surface 143, such that the tip exterior surface appears to be beveled in comparison to the longitudinal axis associated with the central housing 112.

The distal end portion 116 also features a sloping upper surface 144 and a sloping lower surface 146, with the length of the upper surface 144 being greater than the distance of the lower surface 146 due to the curvature of the device 100 in that portion of the device. It will also be appreciated that the area of the distal end aperture 140 is less than the area of the proximal end aperture 128.

In actual use, it is believed that the device can be used by individuals who suffer from cystic fibrosis, emphysema, pulmonary fibrosis, bronchitis, and other illnesses where air is trapped in the lungs and especially in the aforementioned cases where the individual also needs to use supplemental oxygen. The mouthpiece is placed between the lips, with the lips then being closed. The user then exhales through the device until the lungs feel empty of air. Immediately thereafter an inhalation occurs through the nose.

The user then again exhales through the device until the lungs feel empty of air. The steps of inhalation and exhalation are repeated for the next couple of minutes until breathing becomes far less labored.

In actual use, exhalation using the aforementioned device and method has resulted in the expulsion of water vapor and in some cases, mucus, from the lungs. An oxygen saturation test conducted in conjunction with the use of the device of this invention had an oxygen level of 90 reduced after a brief period of exercise to 77, but subsequently rise after 2.1 minutes of using the invention to a level of 91. An additional 1 minute of taking deeps breaths on their own caused the level to rise to 94 before leveling off at 92. Another benefit of using this invention has been that a user has been able to reduce the volume of supplemental oxygen used from 6 liters per minute to 4 liters per minute, yet still maintain the same blood oxygen levels. Finally, the downward slope of the device at its distal end aids in minimizing the inhalation of previously exhaled air with its relatively higher humidity and airborne contaminants.

Due to the size of the device and the choice of fabrication material, the cost of the device is relatively inexpensive. This allows the device to be thrown out after several days of use, which is desirable due to the attachment of airborne contaminants and mucus to the interior wall of the channel. Over time, the volume of air which can be discharged during exhalation can decrease due to this undesirable narrowing of the channel.

While the form of apparatus herein described constitutes a preferred embodiment of the present invention, it is to be understood that the invention is not limited to this precise form of apparatus and that changes may be made therein without departing from the scope of the invention which is defined in the appended claims.

What is claimed is:

1. A small, disposable, medical device comprising
a central housing,
a proximal end portion, and
a distal end portion, said central housing having said proximal end portion at one end of said central housing, and said central housing having said distal end portion at the other end of said central housing, said proximal end portion having an aperture formed therein and said distal end having an aperture formed therein, a channel extending the length of said device from said aperture at said proximal end to said aperture at said distal end.

2. The device according to claim 1 wherein said central housing tapers in width between said proximal end portion and said distal end portion, the width at the distal end portion being less than the width at the proximal end portion.

3. The device according to claim 1 wherein said proximal end portion has a width that is greater than its height.

4. The device according to claim 1 wherein said aperture at said proximal end has an area that is greater than the aperture at said distal end.

5. The device according to claim 1 wherein said aperture at said distal end has a top surface tip and a bottom surface tip, with a tip exterior surface extending from said ton surface tip to said bottom surface tip.

6. The device according to claim 5 wherein said central housing includes a sloping upper surface and a sloping lower surface, said sloping upper surface terminating at said top surface tip, said sloping lower surface terminating at said bottom surface tip.

7. The device according to claim 1 wherein said device is of a length between 1.25″ to 8″.

8. The device according to claim 1 wherein said device is of a length between 1.5″ to 3″.

9. A small, disposable, medical device comprising
a longitudinal member,
a mouthpiece, and
an outflow portion, said longitudinal member having said mouthpiece at one end of said longitudinal member, and said longitudinal member having said outflow portion at the other end of said longitudinal member, said mouthpiece having an aperture formed therein and said outflow portion having an aperture formed therein, a channel extending the length of said device from said aperture at said mouthpiece to said aperture at said outflow end.

10. The device according to claim 9 wherein said longitudinal member tapers in width between said mouthpiece and said outflow portion, the width at the outflow portion being less than the width at said mouthpiece.

11. The device according to claim 9 wherein said mouthpiece has a width that is greater than its height.

12. The device according to claim 9 wherein said aperture at said mouthpiece has an area that is greater than the aperture at said outflow portion.

13. The device according to claim 9 wherein said aperture at said outflow portion has a top surface tip and a bottom surface tip, with a tip exterior surface extending from said top surface tip to said bottom surface tip.

14. The device according to claim 11 wherein said longitudinal member includes a sloping upper surface and a sloping lower surface, said sloping upper surface terminating at said top surface tip, said sloping lower surface terminating at said bottom surface tip.

15. The device according to claim 9 wherein said device is of a length between 1.25″ to 8″.

16. The device according to claim 9 wherein said device is of a length between 1.5″ to 3″.
